(19) United States
(12) Patent Application Publication
(10) Pub. No.: US 2021/0356012 A1
(43) Pub. Date: Nov. 18, 2021

(54) AUTOMOTIVE ACTIVE VIBRATION CONTROL USING CIRCULAR FORCE GENERATORS

(71) Applicant: LORD Corporation, Cleveland, OH (US)

(72) Inventors: Mark Norris, Henrico, NC (US); Stefan Barbulescu, Fuquay Varina, NC (US); Martin Bieber, Oak Island, NC (US); Karl Andrew Kintz, Apex, NC (US)

(73) Assignee: LORD Corporation, Cleveland, OH (US)

(21) Appl. No.: 17/284,447

(22) PCT Filed: Oct. 11, 2019
(86) PCT No.: PCT/US2019/055795

§ 371 Date: Apr. 10, 2021

Related U.S. Application Data
(60) Provisional application No. 62/747,419, filed on Oct. 18, 2018.

(51) Int. Cl. F16F 7/10; B62D 7/22

(52) U.S. Cl. CPC F16F 7/1005; B62D 7/224; G10K 11/16; F16F 2230/18; F16F 2222/08; F16F 2230/08

(57) ABSTRACT

A vehicle active vibration control (AVC) system includes a vehicle having at least an engine, a transmission, a controller area network (CAN) bus, a frame, and a cabin. The vibration control devices (120) are distributed about the frame, with each device including a circular force generator (CFG) (122). At least one sensor is positioned on the frame to detect and measure a noise and/or vibration within the cabin. Each sensor creates an electronic data signal and electrically communicates with a corresponding vibration control device. Each vibration control device receives an electronic data signal from a corresponding sensor and vehicle data from the CAN bus. Each vibration control device processes the electronic data signal and the vehicle data. The CFG of each vibration control device generates a vibration canceling force having a magnitude and phase that attenuates noise and/or vibration within the cabin.

### CROSS-REFERENCE TO RELATED APPLICATION

This application claims priority to U.S. Provisional Patent Application Ser. No. 62/747,419, filed Oct. 18, 2018, the disclosure of which is incorporated herein by reference in its entirety.

### FIELD OF INVENTION

The subject matter disclosed herein generally relates to vibration control and methods for canceling vibrations. More particularly, the subject matter disclosed herein relates to active vibration control within automobiles and trucks by using circular force generators and accompanying methods for canceling vibrations present therein.

### BACKGROUND

Automotive companies use linear technology to control vibrations such as the vibrations induced when engines shut down cylinders during low-power operation to improve efficiency. In this engine cylinder shutdown example, by shutting down engine cylinders the automobile feels different to the driver and passengers as the engine now imparts a lower frequency excitation. For example, in the case of a V-8 engine this happens when the engine is commanded to shut down four (4) cylinders and operate on the remaining four (4) cylinders. When this occurs, the four (4) cylinders remaining cylinders impart a two (2) per engine revolution per minute (RPM) frequency that the driver and/or passenger feel. The common perception by the driver and/or passenger is there is a problem with the vehicle. In some cases, new auto owners return the car because it is believed that there is a problem with the car. To ameliorate this perception, vehicle manufacturers are using linear vibration control technology to reduce two-per-revolution engine vibration in the vehicle, focusing on controlling the vibrations felt by vehicle occupants through the two most common occupant touchpoints, seats and the steering wheel.

Linear actuator technology is especially heavy and expensive for broadband vibration control. The resonance of linear actuation technology is typically tuned below the operating range of the engine. Additionally, such linear actuators are power intensive to operate, and they require a large amount of high-quality metals and rare earth magnetic material in their design. Linear technology is limited in its ability to control complex motions over a wide frequency range.

As illustrated in the prior art example of FIGS. 1A and 1B, vehicle 10 is illustrated with linear actuators 12 that are affixed to different points on the vehicle frame 14. The positioning of the linear actuators 12 on the vehicle frame 14 is dependent upon the model of vehicle 10. Thus, vehicle manufacturers are finding that, to use this technology over varying configurations of vehicles 10, they must position the linear actuators 12 at different positions and/or angles on the vehicle frame 14. Additionally, they must reorient the actuators 12 between 0° and 15°, as shown in FIG. 1A, to gain better performance based on the particular vibration characteristics of each vehicle 10. Further complexity in using linear actuator technology for vibration control occurs because vehicle frame 14 operating deflections over these large frequency ranges are quite complex and change significantly with varying structural configurations of such vehicles 10. As such, many manufacturers struggle to streamline production lines as a result of the need to implement a complex set of linear actuator 12 orientations depending on the vehicle 10 configuration, e.g., varying cab configurations, truck bed length, and the like.

### SUMMARY

This specification discloses systems, devices, and methods for active vibration control using circular force generators. According to a first aspect, an active vibration control (AVC) system is provided for a vehicle. The AVC system comprises a vehicle comprising at least an engine, a transmission, a controller area network (CAN) bus, a frame, and a cabin; a plurality of vibration control devices distributed about the frame of the vehicle, wherein each of the vibration control devices comprises at least one circular force generator (CFG); and at least one sensor positioned on the frame, wherein the at least one sensor is configured to detect and measure a noise and/or vibration on the frame corresponding to a noise and/or vibration within the cabin, wherein the at least one sensor is configured to create an electronic data signal of the noise and/or vibration detected on the frame, and wherein the at least one sensor is in electronic communication with the CFG of at least one of the plurality of vibration control devices; wherein each of the plurality of vibration control devices is configured to electronically receive the electronic data signal from the at least one sensor and to receive vehicle data from the CAN bus; wherein each of the plurality of vibration control devices is configured to process the electronic data signal and the vehicle data; and wherein the CFG of each of the plurality of vibration control devices generates a vibration canceling force having a magnitude and a phase that attenuates the noise and/or vibration within the cabin.

In one aspect, an active vibration control (AVC) system for a vehicle is provided. The AVC comprises a vehicle, a plurality of vibration control devices, and at least one sensor. The vehicle has at least an engine, a transmission, a controller area network (CAN) bus, a frame, and a cabin. The plurality of vibration control devices are distributed about the frame of the vehicle, wherein each of the vibration control devices comprises at least one circular force generator (CFG). The at least one sensor is positioned on the frame, wherein the at least one sensor is configured to detect and measure a noise and/or vibration on the frame corresponding to a noise and/or vibration within the cabin, wherein the at least one sensor is configured to create an electronic data signal of the noise and/or vibration detected on the frame, and wherein the at least one sensor is in electronic communication with the CFG of at least one of the plurality of vibration control devices. Each of the plurality of vibration control devices is configured to electronically receive the electronic data signal from the at least one sensor and to receive vehicle data from the CAN bus. The CFG of each of the plurality of vibration control devices is configured to generate a vibration canceling force having a magnitude and a phase that attenuates the noise and/or vibration within the cabin.

In some embodiments of the AVC system, the noise and/or vibration within the cabin are a result of the engine having at least one cylinder deactivated in a low-power mode to improve fuel efficiency of the vehicle.

In some embodiments of the AVC system, the at least one sensor is an accelerometer.

In some embodiments of the AVC system, each CFG comprises at least two eccentric masses, at least one brushless DC motor integrated with each of the at least two eccentric masses, an integrated controller, and at least one biaxial accelerometer.

In some embodiments of the AVC system, the vehicle data from the CAN bus comprises one or more of a vehicle speed, a transmission gear, an engine speed, an engine torque, and a transmission gear shift event.

In some embodiments of the AVC system, each of the plurality of vibration control devices comprises a look-up table stored in an electronic storage device within the vibration control device.

In some embodiments of the AVC system, each of the plurality of vibration control devices is configured to command the CFG associated therewith to generate a particular force magnitude and phase based on the vehicle information obtained from the CAN bus.

In some embodiments of the AVC system, each CFG is in electronic communication with the CAN bus.

In some embodiments of the AVC system, the transmission gear shift event is received prior to the transmission changing gears to allow for predictive vibration control of the vehicle during the transmission gear shift event.

In some embodiments of the AVC system, each vibration control device comprises electronics configured for electronic communication with every other vibration control device of the plurality of vibration control devices.

In some embodiments of the AVC system, at least one of the plurality of vibration control devices is a steering vibration control device attached to a steering column to control vibration of a steering wheel, which is attached to the steering column, wherein the steering wheel is located within the cabin of the vehicle.

In some embodiments of the AVC system, a spin axis of the CFG of the steering vibration control device is aligned with a longitudinal axis of the steering column.

In some embodiments of the AVC system, the steering vibration control device is configured to control vibration of the steering wheel and/or steering column in a biaxial plane, in which control sensors of the steering vibration control device are oriented normal to the longitudinal axis of the steering column.

In some embodiments of the AVC system, the steering vibration control device is integral to the steering column.

In some embodiments of the AVC system, the vehicle data from the CAN bus comprises vehicle configuration information, and wherein the AVC system is configured to determine the control models and software parameters used for controlling vibration and/or noise within the cabin.

In some embodiments of the AVC system, one or more of the plurality of vibration control systems is configured to receive a command from the vehicle control system to generate a warning perceptible to one or more occupants of the vehicle.

In some embodiments of the AVC system, the force magnitude and/or frequency generated by one or more of the vibration control devices is different for a safety warning than for an informational alert.

In some embodiments of the AVC system, the safety warning pertains to one or more driver attentiveness, an imbalanced or shifted load of the vehicle, and a warning to turn on headlights of the vehicle based on an ambient light level.

### BRIEF DESCRIPTION OF THE DRAWINGS

FIG. 1A is an example of an active vibration control system using linear force generators as known in the prior art, showing how linear actuators must be reoriented to meet vibration requirements depending on automobile configuration.

FIG. 1B illustrates an example installation position of the linear force generators in the vehicle shown in FIG. 1A.

FIG. 2A illustrates a vehicle equipped with an active vibration control system using circular force generators.

FIG. 2B illustrates the vibration control device described herein.

FIG. 2C illustrates a CFG spin direction with an example distribution and orientation to provide improved structural control coupling compared with linear actuator technology.

FIG. 3 is a graphical illustration of a representative gear shift event of engine RPM over time illustrating that the controller area network (CAN) can provide advance information of the gear shift event that the CFG control system can leverage to provide improved tracking for vibration attenuation.

FIG. 4 is a graphical illustration of an example tracking error of CFG speed where advance information of the gear shift event is not provided to the CFG controller to provide reactive vibration control during the gear shift event.

FIG. 5 is a graphical illustration of an example of tracking error of CFG speed where advance information of the gear shift event is provided to the CFG controller to provide proactive, rather than reactive, vibration control during the gear shift event.

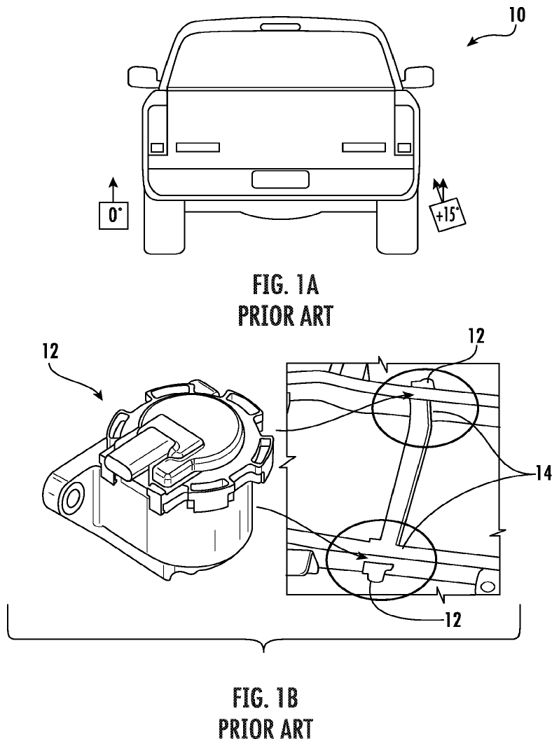

### DETAILED DESCRIPTION

This specification discloses systems, devices, and methods for active vibration control (AVC) using circular force generators (CFGs). Circular Force Generator (CFG) technology overcomes at least some of the limitations associated with linear technology. Compared to the linear actuator technology discussed in the background, CFG technology requires significantly less expensive metals and magnetic material, weighs significantly less, generates more force, and is able to adapt to the vibratory conditions in the vehicle without special tuning for each vehicle frame on the production line, thereby requiring fewer force generators on a vehicle and improving the efficiency of the manufacturing process. Additionally, CFGs are significantly less expensive to build and install than are linear force generators. Accordingly, automotive CFG technology can leverage brushless direct current (BLDC) motor technology that is used extensively in the consumer drone market. The BLDC motors are extremely reliable and significantly less expensive as compared to linear force generator technology.

CFGs generate a planar force and moment that can more easily control vibration in a complex structural response compared to linear force generator technology, especially over large ranges of operating frequencies. As used herein, the terms automobile and vehicle are meant to address the entire spectrum of automotive vehicles having a gas or diesel engine, the spectrum including, but not being limited to passenger cars, light trucks, medium to heavy trucks. Further aspects of active vibration control using circular force generators can be found in PCT Patent Application Numbers PCT/US19/23081 and PCT/US19/23085, both of which are incorporated by reference herein in their entirety.

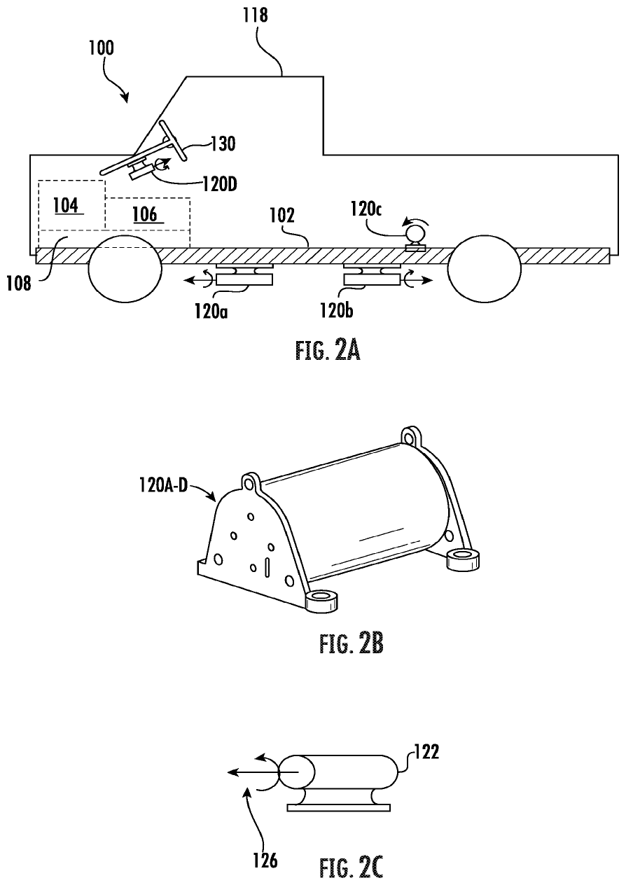

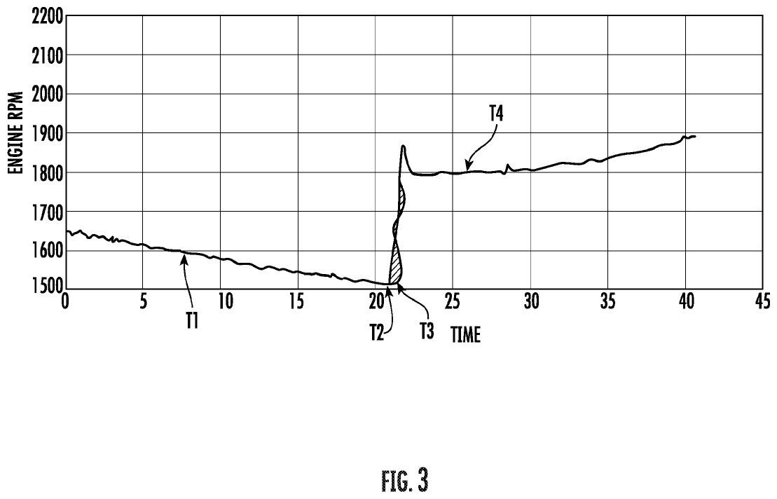

FIG. 2A illustrates a side view of a vehicle 100 equipped with an active vibration control system using three example CFGs 120A-C on vehicle frame 102. One example CFG 120A-D is illustrated in FIG. 2B. As stated before, vehicle 100 can be any appropriate type of automobile, e.g., a car or a truck. Vehicle 100 is shown as a pick-up truck for purposes of illustration. As illustrated, vehicle 100 includes a vehicle frame 102, an engine 104, a transmission 106, and a vehicle control system 108. Vehicle 100 comprises a cabin 118 with a steering wheel 130, which is grasped by a driver of vehicle 100 during operation and through which vehicle steering inputs are transmitted to vehicle 100 by the driver, located therein. Cabin 118 can be, for example and without limitation, an open, partially enclosed, or fully enclosed structure of the vehicle 100 that defines, for example, an interior of vehicle 100 and in which one or more occupants of vehicle 100 can be transported while vehicle 100 is in motion. Vehicle 100 includes a suitable number of vibration control devices 120A-C mounted on vehicle frame 102 as well as a fourth, of steering, vibration control device 120D attached at a suitable location to steering wheel 130, such as on the steering column. Vibration control devices 120A-D can be interconnected with each other and connected to vehicle control system 108 via a vehicle wiring harness. The wiring harness can be implemented using any appropriate wiring system for providing data and/or power to vibration control devices 120A-D. Each of vibration control devices 120A-D can receive power, e.g., 12-volt power from vehicle 100, and, in some instances, each of vibration control devices 120A-D has individual access to an analog engine tachometer signal. Vibration control devices 120A-D are configured to perform active vibration control to reduce noise and vibration within cabin 118 of vehicle 100 and/or tactile vibration of steering wheel 130, such as may occur from engine 104 deactivating a subset of cylinders during a low-power operation mode.

Each of vibration control devices 120A-D includes a circular force generator (CFG) 122. A CFG 122 is a device including at least one mass and at least one motor configured to rotate the mass. FIG. 2C is illustrates a perspective view of an example CFG 122. FIG. 2C illustrates spin direction 126 of CFG 122. Examples of circular force generators are described further in PCT Patent Application Numbers PCT/US19/23081 and PCT/US19/23085.

Each of vibration control devices 120A-D also includes a control system to control the circular force generator. Vehicle control system 108 includes a motor control circuit configured for controlling the motor to produce a commanded rotating force. Examples of vibration control devices 120A-D are described further in PCT Patent Application Numbers PCT/US19/23081 and PCT/US19/23085.

In general, vibration control devices 120A-D can be placed at any appropriate location on vehicle 100, and the number and location of vibration control devices 120A-D can be selected to meet design requirements for particular types of vehicles. As shown in FIG. 2A, first and second vibration control devices 120A-B are mounted in opposite directions along the length of vehicle 100 on one side of vehicle 100, a third vibration control device 120C is mounted perpendicular to first and second vibration control devices 120A-B along the width of vehicle 100, and a fourth, or steering, vibration control device 120D is mounted, for example, to the steering column, to which steering wheel 130 is coupled.

As disclosed herein, CFG technology overcomes the limitations associated with linear force generator technology. CFGs generate a circular planar force that can more easily, e.g., with greater accuracy and/or precision, control vibration in a complex structural response as compared with linear force generator technology, especially over large operating frequency ranges.

Fundamentally, the mechanics as to how CFG technology can work more effectively than linear technology in the way that CFG technology can produce noise and/or vibration canceling motions to generate a complex structural attenuation response over a large operating frequency range. Linear force generators are only capable of generating a linear force, whereas CFGs can be used to create more complex planar forces to generate commandable force magnitude and phase. In the automotive environment, the commandable force magnitude and phase can be distributed to more effectively couple with complex operating deflection shapes of frame 102 and cabin 118, or other suitable vehicle structure, and CFG 122 does not have to be reoriented based on the vehicle 100 configuration. This is illustrated in FIGS. 2A and 2B.

As mentioned, CFG technology can be implemented in a multitude of ways. Using small brushless direct current (BLDC) motors, CFG vibration control can be implemented with two (2) co-rotating eccentric masses driven by two (2) separate small BLDC motors. In this configuration the motors spin at the control frequency, and the magnitude and phase of each eccentric mass is controlled by collocated motor control electronics of vibration control devices 120A-D. A system central control processor, such as may be included in vehicle control system 108, communicates with each vibration control device 120A-D in the active vibration control system to command a force magnitude and relative phase with respect to the automobile engine tachometer. Vehicle control system 108 provides an input command to CFG 122 of each vibration control device 120A-D to create an AVC system where CFGs 122 work collaboratively together to reduce noise and/or vibration in the cabin 118 and the steering wheel 130 of the vehicle 100.

To improve performance of CFG tracking, especially through gear shift events, CFG 122 of each vibration control device 120A-D accesses the vehicle controller area network (CAN) bus to provide advance knowledge of a gear shift event, such that the force magnitude and relative phase generated by each CFG 122 can be proactively altered based on the anticipated change in vehicle vibration during gear shifts, rather than providing only reactive control that can lead to tracking errors, as will be discussed hereinbelow. The CAN bus commands the vehicle transmission 106 to shift gears and, as such, this event may take a period of time in milliseconds, which is sufficient to allow CFG 122 to change speed and/or orientation of the rotating masses located therein to maintain better tracking of vibration control during gear shift events, as opposed to the delay generated when using the engine tachometer alone to force CFG 122 to “catch-up,” as is the case when the control architecture is only reactive, rather than proactive. This improved control behavior is illustrated in the graphs of FIGS. 3-5.

CFG 122 and control system can appear in various architectures. These architectures are exemplary and not meant to be limiting. These architectures vary in complexity, but each architecture is capable of achieving the desired result of reducing the vibrations perceived by the occupants of vehicle 100 at one or more predetermined touchpoints of vehicle 100.

In one embodiment, the AVC system comprises three (3) substantially identical vibration control devices 120A-C, each of which is attached to vehicle 100 on vehicle frame 102, and a fourth, or steering, vibration control device 120D, which can be a different size and/or configured to generate a different magnitude force and/or relative phase, which is attached to vehicle 100 adjacent steering wheel 130, such as, for example, on the steering column. In some embodiments, steering vibration control device 120D comprises a micro CFG 122 that is configured to be coupled to the steering column to control (e.g., cancel and/or minimize) vibration perceived by the driver through steering wheel 130 of the vehicle. CFG 122 of each vibration control device 120A-D comprises at least two eccentric rotating masses, a BLDC motor for each eccentric mass and configured to drive each eccentric mass, and the associated electronics and software/firmware (collectively, the “integrated controller”) to generate a vibration canceling force magnitude and relative phase. Alternatively, each vibration control device 120A-D may have a single external controller or all of vibration control devices 120A-D may have a single external controller. Additionally, in some embodiments, each vibration control device 120A-D can have the capability to run the system control software (Filtered-X algorithm, for example). Each vibration control device 120A-D can have an integrated biaxial accelerometer or sensor, for example, where the accelerometer directions are in the same plane as the CFG force. Each vibration control device 120A-D, as well as the components thereof, is powered by the vehicle power bus rail (e.g., a 12-volt battery) and has electronic access to the analog engine tachometer and vehicle CAN bus. Such an AVC system can be considered as having a “closed-loop” control architecture.

In any of the embodiments disclosed herein, the sensors used to detect noise and/or vibration within the cabin, which can be referred to as “control” sensors, can be positioned discretely from one or more of vibration control devices 120A-D. In some embodiments, these sensors are vertical accelerometers that are attached to frame 102 of vehicle 100 on opposite sides of frame 102. In some embodiments, these sensors are attached in positions corresponding to locations along the length of frame 102, as measured from the front to the back of vehicle 100, in positions corresponding to the positions at which the driver and/or passenger are located within cabin 118. In some embodiments, further sensors may be used along the frame at positions at which other occupants of cabin 118 may be seated, for example, in a second and/or third row of seating inside cabin 118 of vehicle 100, which may be, by way of non-limiting example, a sedan, a coupe, a convertible, a sport utility vehicle (SUV), a minivan, a passenger van, a cargo van, or any configuration of truck. It is advantageous in some embodiments to use such discretely positioned sensors, either in addition to or instead of, the sensors that can be integral to one or more of vibration control devices 120A-D, since such discretely positioned sensors can be easier to install, require a less complex wiring harness, and is generally less expensive. In some embodiments, the discrete sensors attached to frame 102 of vehicle 100 can provide substantially similar performance (e.g., substantially similar attenuation and/or reduction of noise and/or vibration within cabin 118) to sensors that are positioned within cabin 118.

During system initialization, it can be advantageous for all of vibration control devices 120A-D to electronically communicate with each other through the CAN bus to determine which vibration control device 120A-D is the “master” and which vibration control device(s) 120A-D are the “slave” units. The “master” vibration control device 120A-D then implements a system control algorithm to reduce vibration detected at all integrated accelerometers of vibration control devices 120A-D in the system.

In another embodiment, the AVC system comprises three (3) substantially identical vibration control devices 120A-C, each of which is attached to vehicle 100 on the vehicle frame 102, and a fourth, or steering, vibration control device 120D, which can be a different size and/or configured to generate a different magnitude force and/or relative phase, which is attached to vehicle 100 adjacent steering wheel 130, such as, for example, on the steering column. CFG 122 of each vibration control device 120A-D comprises at least two (2) eccentric rotating masses, a BLDC motor for each eccentric mass and configured to drive each eccentric mass, and the associated electronics and software/firmware to generate a vibration canceling force magnitude and relative phase. In some embodiments, the steering vibration control device 120D comprises a micro CFG 122 that is configured to be coupled to the steering column to control (e.g., cancel and/or minimize) vibration perceived by the driver through steering wheel 130 of the vehicle. Each vibration control device 120A-D is in electronic communication with the vehicle CAN bus and each vibration control device 120A-D has access to the analog engine tachometer. In this embodiment, each vibration control device 120A-D has a look-up table stored in its software and, depending on operational parameters like engine speed, torque, and transmission gear selection provided through the CAN bus, each vibration control device 120A-D acts independently (i.e., not in concert or unison) to generate a particular force magnitude and phase depending on the operational parameters. Such an AVC system can be considered as having an “open-loop” control architecture.

In some embodiments, each of vibration control devices 120A-D stores a look-up table and lacks a vibration sensor, such that vibration control devices 120A-D generate force magnitudes and phases using only engine parameters and the look-up table. In some other embodiments, each of vibration control devices 120A-D stores a look-up table and additionally includes a vibration sensor, such that vibration control devices 120A-D generate force magnitudes and phases using engine parameters, the look-up table, and sensor data from the vibration sensors. In some other embodiments, each of vibration control devices 120A-D includes a vibration sensor and lacks a look-up table, such that vibration control devices 120A-D generate force magnitudes and phases using sensor data from the vibration sensors and optionally the engine parameters.

In some examples, to improve performance of CFG tracking, especially during gear shift events, each vibration control device 120A-D has access to the vehicle CAN bus to allow vibration control devices 120A-D to have advance knowledge of a gear shift event. Vehicle control system 108 commands the vehicle transmission 106 to shift gears using the CAN bus and, as such, this gear shift event may occur over a period of time measured, for example, in milliseconds, which is sufficient to allow CFG 122 to begin changing the speed of rotation of one or both eccentric masses (e.g., to increase or decrease the speed of one or both of the eccentric masses) to maintain better tracking of vibration control during gear shift events. This behavior is advantageous compared to the delay generated when the signal for the engine tachometer is used alone, in which case vibration control devices 120A-D must react to the change in noise and/or vibration detected, rather than proactively changing operational frequencies proactively, e.g., before or substantially simultaneously as the occurrence of the gear shift event. The advantages of tracking, or accuracy, of vibration control in this proactive manner is described further below with reference to FIGS. 3-5.

FIGS. 3-5 illustrate, using engine RPM graphs, the effect of a vibration control device altering a force command prior to the occurrence of a gear shift event. FIG. 3 shows a graph with engine RPM plotted on the vertical (Y) axis and time plotted on the horizontal (X) axis. The graph illustrates a gear shift from third gear, at time T1, to second gear, at time T4. At time T2, vehicle control system 108 sends data on the vehicle CAN bus indicating that a gear shift of transmission 106 is imminent, e.g., a command to transmission 106 to cause the gear shift. At time T3, the transmission initiates the gear shift.

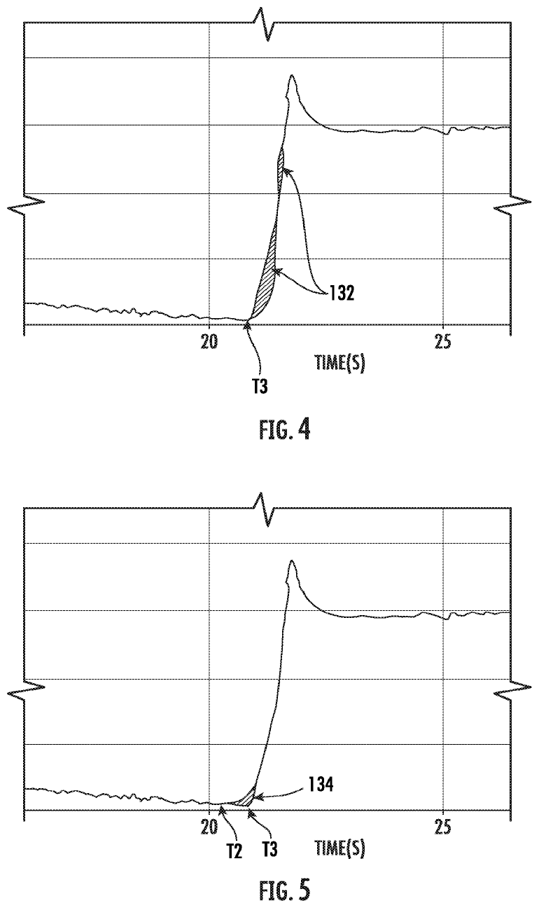

FIG. 4 shows a portion of a modified version of the graph shown in FIG. 3 that illustrates tracking error when the “open-loop” control architecture described elsewhere herein is utilized, in which vibration control devices 120A-D do not use the vehicle data on the vehicle CAN bus indicating that the gear shift is imminent. The tracking error is illustrated as dashed area 132 between the engine RPM and a force command of one or more of vibration control devices 120A-D. Vibration control devices 120A-D must, therefore, shift initiating altering their respective force commands reactively, e.g., at time T3 after or substantially simultaneously to when the actual gear shift occurs, thereby attempting to recover from, or “catch-up” with, the fast change in engine RPM during the gear shift event.

FIG. 5 shows a portion of a modified version of the graph shown in FIG. 3 that illustrates tracking error when the “closed-loop” control architecture described elsewhere herein is utilized, in which the vibration control device uses the vehicle data on the vehicle CAN bus indicating that the gear shift is imminent. The tracking error is illustrated as dashed area 134 between the engine RPM and a force command of one or more of vibration control devices 120A-D. Vibration control devices 120A-D are thus configured to initiate altering their respective force commands proactively, e.g., at time T2 prior to the actual occurrence of the gear shift at time T3 during the gear shift event, so that the respective force commands do not have to recover from, or “catch-up” with, the fast change in engine RPM during the gear shift event.

In yet another embodiment, the AVC system comprises at least two substantially identical vibration control devices 120A-B mounted on vehicle frame 102 and a third, or steering, vibration control device 120D, which comprises a smaller, or micro, CFG 122 that is attached to the steering column. Micro CFG 122 of steering vibration control device 120D controls vibration experienced by the driver through steering wheel 130. Micro CFG 122 of steering vibration control device 120D is better able to couple to the steering column and cancel/minimize the vibration as compared with frame mounted CFGs 122. CFG 122 of each vibration control device 120A, 120B, 120D comprises at least two (2) eccentric rotating masses, a BLDC motor for each eccentric mass and configured to drive each eccentric mass, and the associated electronics and software/firmware to generate a vibration canceling force magnitude and relative phase. In some embodiments, steering vibration control device 120D comprises a micro CFG 122 that is configured to be coupled to the steering column to control (e.g., cancel and/or minimize) vibration perceived by the driver through steering wheel 130 of the vehicle. CFG 122 of each vibration control device 120A, 120B, 120D comprises at least two eccentric rotating masses, a BLDC motor for each eccentric mass and configured to drive each eccentric mass, and the associated electronics and software/firmware (collectively, the “integrated controller”) to generate a vibration canceling force magnitude and relative phase. Alternatively, each vibration control device 120A, 120B, 120D may have a single external controller or all of the vibration control devices 120A, 120B, 120D may have a single external controller. Additionally, in some embodiments, each vibration control device 120A, 120B, 120D can have the capability to run the system control software (Filtered-X algorithm, for example). Each vibration control device 120A, 120B, 120D can have an integrated biaxial accelerometer or sensor, for example, where the accelerometer directions are in the same plane as the CFG force. Each vibration control device 120A, 120B, 120D, as well as the components thereof, is powered by the vehicle power bus rail (e.g., a 12-volt battery) and has electronic access to the analog engine tachometer and vehicle CAN bus. Such an AVC system can be considered as having a “closed-loop” control architecture.

During system initialization, it can be advantageous for all of vibration control devices 120A, 120B, 120D to electronically communicate with each other through the CAN bus to determine which vibration control device 120A, 120B, 120D is the “master” and which vibration control device(s) 120A, 120B, 120D are the “slave” units. The “master” vibration control device 120A, 120B, 120D then implements a system control algorithm to reduce vibration detected at all integrated accelerometers of vibration control devices 120A, 120B, 120D in the system.

In yet another embodiment, the AVC system comprises at least two substantially identical vibration control devices 120A-B mounted on vehicle frame 102 and a third, or steering, vibration control device 120D, which comprises a smaller, or micro, CFG 122 that is attached to the steering column. Micro CFG 122 of steering vibration control device 120D controls vibration experienced by the driver through steering wheel 130. Micro CFG 122 of steering vibration control device 120D is better able to couple to the steering column and cancel/minimize the vibration as compared with frame mounted CFGs 122. CFG 122 of each vibration control device 120A, 120B, 120D comprises at least two (2) eccentric rotating masses, a brushless DC motor for each eccentric mass and configured to drive each eccentric mass, and the associated electronics and software/firmware to generate a vibration canceling force magnitude and relative phase. In some embodiments, steering vibration control device 120D comprises a micro CFG 122 that is configured to be coupled to the steering column to control (e.g., cancel and/or minimize) vibration perceived by the driver through steering wheel 130 of the vehicle. Each vibration control device 120A, 120B, 120D is in electronic communication with the vehicle CAN bus and each vibration control device 120A, 120B, 120D has access to the analog engine tachometer. In this embodiment, each vibration control device 120A, 120B, 120D has a look-up table stored in its software and, depending on operational parameters like engine speed, torque, and transmission gear selection provided through the CAN bus, each vibration control device 120A, 120B, 120D acts independently (i.e., not in concert or unison) to generate a particular force magnitude and phase depending on the operational parameters. Such an AVC system can be considered as having an “open-loop” control architecture.

In still another embodiment, the AVC system comprises at least one vibration control device 120A mounted on the driver-side and/or passenger-side of vehicle frame 102 and a second, or steering, vibration control device 120D, which comprises a smaller, or micro, CFG 122 that is attached to the steering column. Micro CFG 122 of steering vibration control device 120D controls vibration experienced by the driver through steering wheel 130. Micro CFG 122 of steering vibration control device 120D is better able to couple to the steering column and cancel/minimize the vibration as compared with frame mounted CFGs. CFG 122 of each vibration control device 120A, 120D comprises at least two (2) eccentric rotating masses, a BLDC motor for each eccentric mass and configured to drive each eccentric mass, and the associated electronics and software/firmware to generate a vibration canceling force magnitude and relative phase. In some embodiments, steering vibration control device 120D comprises a micro CFG 122 that is configured to be coupled to the steering column to control (e.g., cancel and/or minimize) vibration perceived by the driver through steering wheel 130 of the vehicle 100. CFG 122 of each vibration control device 120A, 120D comprises at least two eccentric rotating masses, a BLDC motor for each eccentric mass and configured to drive each eccentric mass, and the associated electronics and software/firmware (collectively, the “integrated controller”) to generate a vibration canceling force magnitude and relative phase. Alternatively, each vibration control device 120A-D may have a single external controller or all of vibration control devices 120A, 120D may have a single external controller. Additionally, in some embodiments, each vibration control device 120A, 120D can have the capability to run the system control software (Filtered-X algorithm, for example). Each vibration control device 120A, 120D can have an integrated biaxial accelerometer or sensor, for example, where the accelerometer directions are in the same plane as the CFG force. Each vibration control device 120A, 120D, as well as the components thereof, is powered by the vehicle power bus rail (e.g., a 12-volt battery) and has electronic access to the analog engine tachometer and vehicle CAN bus. Such an AVC system can be considered as having a “closed-loop” control architecture.

During system initialization, it can be advantageous for all of vibration control devices 120A, 120D to electronically communicate with each other through the CAN bus to determine which vibration control device 120A, 120D is the “master” and which vibration control device(s) 120A, 120D are the “slave” units. The “master” vibration control device 120A, 120D then implements a system control algorithm to reduce vibration detected at all integrated accelerometers of vibration control devices 120A, 120D in the system.

In still another embodiment, the AVC system comprises at least one vibration control device 120A mounted on the driver-side and/or passenger-side of the vehicle frame 102 and a second, or steering, vibration control device 120D, which comprises a smaller, or micro, CFG 122 that is attached to the steering column. Micro CFG 122 of steering vibration control device 120D controls vibration experienced by the driver through steering wheel 130. Micro CFG 122 of steering vibration control device 120D is better able to couple to the steering column and cancel/minimize the vibration as compared with frame mounted CFGs. CFG 122 of each vibration control device 120A, 120B, 120D comprises at least two (2) eccentric rotating masses, a BLDC motor for each eccentric mass and configured to drive each eccentric mass, and the associated electronics and software/firmware to generate a vibration canceling force magnitude and relative phase. In some embodiments, steering vibration control device 120D comprises a micro CFG 122 that is configured to be coupled to the steering column to control (e.g., cancel and/or minimize) vibration perceived by the driver through steering wheel 130 of the vehicle. Each vibration control device 120A, 120D is in electronic communication with the vehicle CAN bus and each vibration control device 120A, 120D has access to the analog engine tachometer. In this embodiment, each vibration control device 120A, 120D has a look-up table stored in its software and, depending on operational parameters like engine speed, torque, and transmission gear selection provided through the CAN bus, each vibration control device 120A, 120D acts independently (i.e., not in concert or unison) to generate a particular force magnitude and phase depending on the operational parameters. Such an AVC system can be considered as having an “open-loop” control architecture.

Other embodiments of the current invention will be apparent to those skilled in the art from a consideration of this specification or practice of the invention disclosed herein. Thus, the foregoing specification is considered merely exemplary of the current invention with the true scope thereof being defined by the following claims.

1. An active vibration control (AVC) system for a vehicle, the AVC system comprising:
a vehicle comprising at least an engine, a transmission, a controller area network (CAN) bus, a frame, and a cabin;
a plurality of vibration control devices distributed about the frame of the vehicle, wherein each of the vibration control devices comprises at least one circular force generator (CFG); and
at least one sensor positioned on the frame, wherein the at least one sensor is configured to detect and measure a noise and/or vibration on the frame corresponding to a noise and/or vibration within the cabin, wherein the at least one sensor is configured to create an electronic data signal of the noise and/or vibration detected on the frame, and wherein the at least one sensor is in electronic communication with the CFG of at least one of the plurality of vibration control devices;
wherein each of the plurality of vibration control devices is configured to electronically receive the electronic data signal from the at least one sensor and to receive vehicle data from the CAN bus;
wherein each of the plurality of vibration control devices is configured to process the electronic data signal and the vehicle data; and
wherein the CFG of each of the plurality of vibration control devices is configured to generate a vibration canceling force having a magnitude and a phase that attenuates the noise and/or vibration within the cabin.

2. The AVC system of claim 1, wherein the noise and/or vibration within the cabin are a result the engine having at least one cylinder deactivated in a low-power mode to improve fuel efficiency of the vehicle.

3. The AVC system of claim 1, wherein the at least one sensor is an accelerometer.

4. The AVC system of claim 1, wherein each CFG comprises at least two eccentric masses, at least one brushless DC motor integrated with each of the at least two eccentric masses, an integrated controller, and at least one biaxial accelerometer.

5. The AVC system of claim 4, wherein the vehicle data from the CAN bus comprises one or more of a vehicle speed, a transmission gear, an engine speed, an engine torque, and a transmission gear shift event.

6. The AVC system of claim 5, wherein each of the plurality of vibration control devices comprises a look-up table stored in an electronic storage device within the vibration control device.

7. The AVC system of claim 6, wherein each of the plurality of vibration control devices is configured to command the CFG associated therewith to generate a particular force magnitude and phase based on the vehicle information obtained from the CAN bus.

8. The AVC system of claim 1, wherein each CFG is in electronic communication with the CAN bus.

9. The AVC system of claim 8, wherein the vehicle data from the CAN bus comprises one or more of a vehicle speed, a transmission gear, an engine speed, an engine torque, and a transmission gear shift event.

10. The AVC system of claim 9, wherein the transmission gear shift event is received prior to the transmission changing gears to allow for predictive vibration control of the vehicle during the transmission gear shift event.

11. The AVC system of claim 1, wherein each vibration control device comprises electronics configured for electronic communication with every other vibration control device of the plurality of vibration control devices.

12. The AVC system of claim 1, wherein at least one of the plurality of vibration control devices is a steering vibration control device attached to a steering column to control vibration of a steering wheel, which is attached to the steering column, wherein the steering wheel is located within the cabin of the vehicle.

13. The AVC system of claim 12, where a spin axis of the CFG of the steering vibration control device is aligned with a longitudinal axis of the steering column.

14. The AVC system of claim 13, wherein the steering vibration control device is configured to control vibration of the steering wheel and/or steering column in a biaxial plane, in which control sensors of the steering vibration control device are oriented normal to the longitudinal axis of the steering column.

15. The AVC system of claim 12, wherein the steering vibration control device is integral to the steering column.

16. The AVC system of claim 1, wherein the vehicle data from the CAN bus comprises vehicle configuration information, and wherein the AVC system is configured to determine the control models and software parameters used for controlling vibration and/or noise within the cabin.

17. The AVC system of claim 1, wherein one or more of the plurality of vibration control systems is configured to receive a command from the vehicle control system to generate a warning perceptible to one or more occupants of the vehicle.

18. The AVC system of claim 17, wherein the force magnitude and/or frequency generated by one or more of the vibration control devices is different for a safety warning than for an informational alert.

19. The AVC system of claim 18, wherein the safety warning pertains to one or more driver attentiveness, an imbalanced or shifted load of the vehicle, and a warning to turn on headlights of the vehicle based on an ambient light level.
